(19) United States
(12) Patent Application Publication
(10) Pub. No.: US 2016/0142800 A1
(43) Pub. Date: May 19, 2016

(54) In-Wall/In-Ceiling Speaker with Grid Assembly

(71) Applicant: Tzu-Chung Chang, Kaohsiung City (TW)

(72) Inventor: Tzu-Chung Chang, Kaohsiung City (TW)

(21) Appl. No.: 14/547,221

(22) Filed: Nov. 19, 2014

(51) Int. Cl. H04R 1/02; F16M 13/02

(52) U.S. Cl. CPC H04R 1/025; F16M 13/027; H04R 2201/021

(57) ABSTRACT

An in-wall/in-ceiling speaker with grid assembly includes a grid with a plurality of first engagement portions and a body with a plurality of second engagement portions. The grid firmly couples with the body by engaging the plurality of second engagement portions with the plurality of first engagement portions, which reduces the production costs of the in-wall/in-ceiling speaker with grid assembly and prevents the grid from falling off from the body.

### BACKGROUND OF THE INVENTION

1. Field of the Invention

The present invention relates to an in-wall/in-ceiling speaker with grid assembly and, more particularly, to an in-wall/in-ceiling speaker including a grid assembly that is able to firmly couple a grid with a body.

2. Description of the Related Art

Referring to FIG. 1, a conventional in-wall/in-ceiling speaker mounted in a building's wall or ceiling is shown. The in-wall/in-ceiling speaker roughly includes a grid 1, a body 2 and a magnet 3. The magnet 3 is adhered to the body 1. The grid 1 can be an iron-grid or any kind of grid with a frame made of hard/soft magnetic material. Therefore, the magnet 3 attracts the grid 1, and the grid 1 may couple with the body 2 through magnetic attachment between the grid 1 and the magnet 3. Although only partial meshes are shown in FIG. 1, a person having ordinary skill in the art can understand that the meshes are likely to be formed on the entire grid 1.

However, since the production process of this in-wall/in-ceiling speaker requires extra component such as a magnet 3 and extra step such as adhering the magnet 3 to the body, the production costs of the in-wall/in-ceiling speaker are increased. Additionally, in practical use of this in-wall/in-ceiling speaker, since the magnet 3 is adhered to the body 2, the adhesion strength between the magnet 3 and the body 2 may decrease as time goes on. It can lead to disengagement of the magnet 3. Besides, the magnetic force of the magnet 3 can decrease under a long term of use, such that the remaining magnetic force of the magnet 3 is too small to securely attach the grid 1 to the body 2. In both cases, the grid 1 tends to fall off from the body 2.

### SUMMARY OF THE INVENTION

An objective of the present disclosure is to provide an in-wall/in-ceiling speaker with grid assembly including a grid having a plurality of first engagement portions and a body having a plurality of second engagement portions. The grid can firmly couple with the body by engaging the plurality of second engagement portions with the plurality of first engagement portions.

The present invention fulfills the above objective by providing an in-wall/in-ceiling speaker with grid assembly comprising a grid and a body. The grid includes a plurality of first engagement portions, and the body includes a plurality of second engagement portions. The grid couples with the body by engaging the plurality of second engagement portions with the plurality of first engagement portions.

Each first engagement portion can be in a form of a protrusion. Each second engagement portion can be in a form of a notch. Each second engagement portion can have a hook portion extending along the second engagement portion.

Each first engagement portion can be received in a respective one of the plurality of second engagement portions, and the hook portion of the second engagement portion can limit the position of the first engagement portion.

The grid and the body can be in circular shapes. The plurality of first engagement portions can be formed on an outer periphery of the grid, and the plurality of second engagement portions can be formed on an outer periphery of the body.

The grid and the body can be in quadrilateralshapes. The plurality of first engagement portions can be formed at a side of the grid, and the plurality of second engagement portions can be formed at a side of the body

The number of the plurality of first engagement portions can be equal to the number of the plurality of second engagement portions.

By provision of the in-wall/in-ceiling speaker with grid assembly, the engagement structures including the plurality of first engagement portions and the plurality of second engagement portions have advantages of simple production, convenient installation and decent appearance. Furthermore, the grid firmly couples with the body by engaging the plurality of second engagement portions with the plurality of first engagement portions, which reduces the production costs of the in-wall/in-ceiling speaker with grid assembly and prevents the grid from falling off from the body.

The present invention will become clearer in light of the following detailed description of illustrative embodiments of this invention described in connection with the drawings.

### BRIEF DESCRIPTION OF THE DRAWINGS

The present invention will become more fully understood from the detailed description given hereinafter and the accompanying drawings which are given by way of illustration only, and thus are not limitative of the present invention, including:

FIG. 1 is an exploded, perspective view of a conventional in-wall/in-ceiling speaker.

FIG. 2 is a perspective view of a grid in circular configuration of an embodiment according to the present invention.

FIG. 3 is a perspective view of a body in circular configuration of an embodiment according to the present invention.

FIG. 4 is a perspective view of the grid and the body in circular configurations with partial enlarged detail of first and second engagement portions of another embodiment according to the present invention.

FIG. 5 is a perspective view of a grid in quadrilateral configuration of another embodiment according to the present invention.

FIG. 6 is a perspective view of a body in quadrilateral configuration of another embodiment according to the present invention.

FIG. 7 is a perspective view of the grid and the body in quadrilateral configurations with partial enlarged detail of first and second engagement portions of another embodiment according to the present invention.

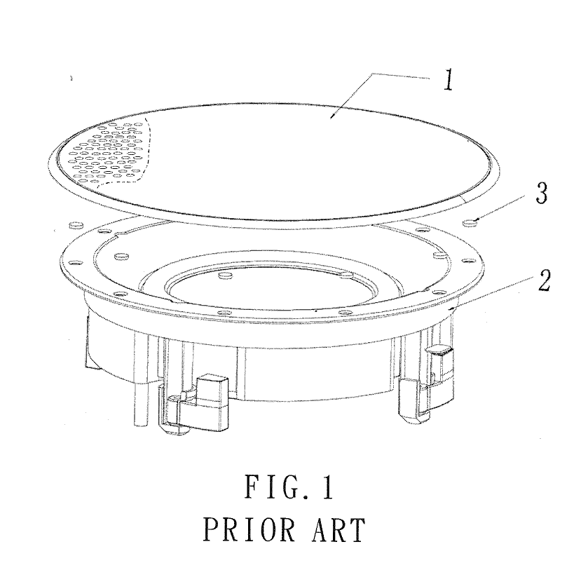

### DETAILED DESCRIPTION OF THE INVENTION

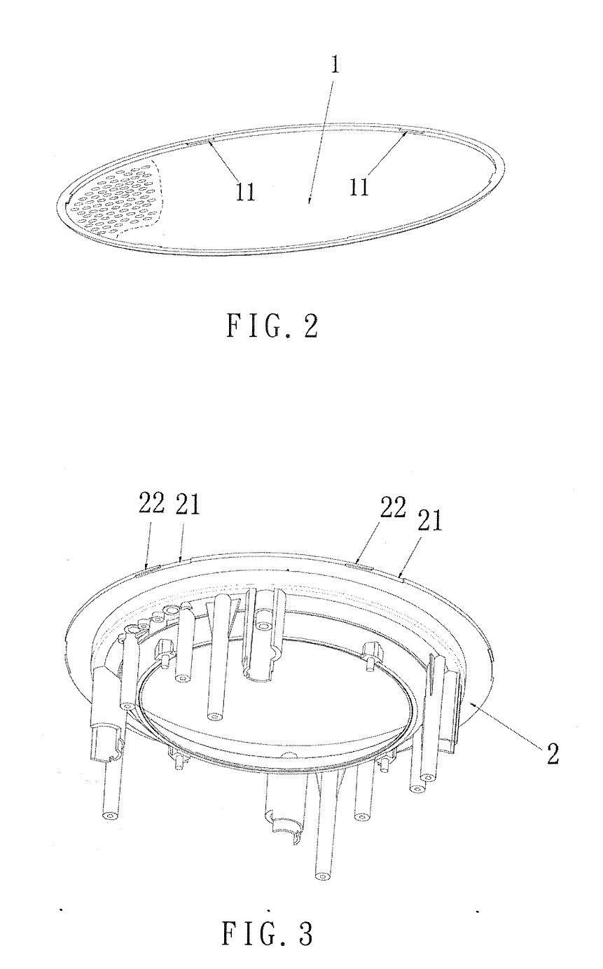

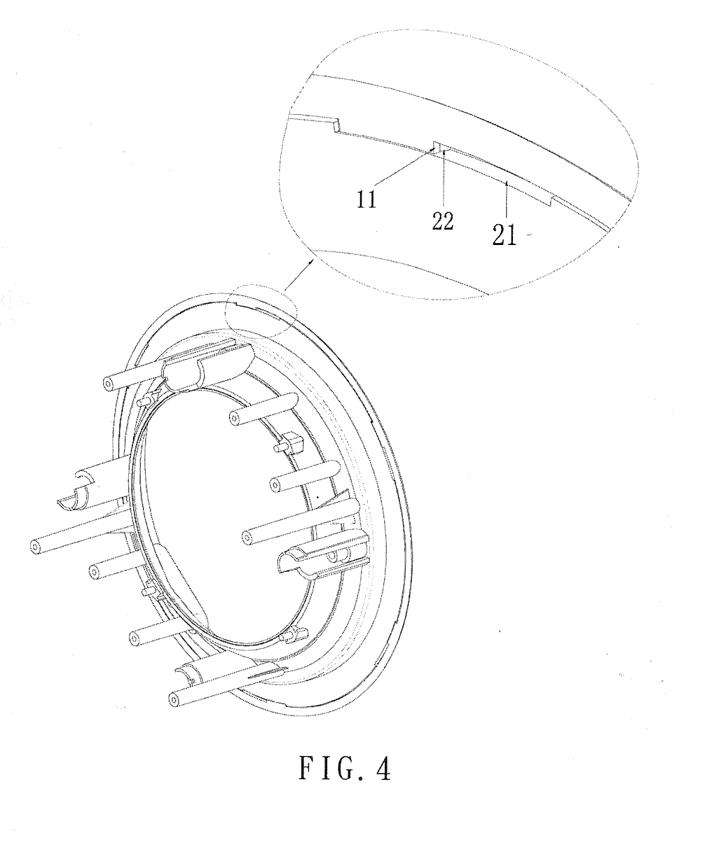

With reference to FIGS. 2-4, an in-wall/in-ceiling speaker with grid assembly according to an embodiment of the present invention includes a grid 1 and a body 2 coupled with the grid 1. Although only partial meshes are shown in FIG. 2, a person having ordinary skill in the art can understand that the meshes can be formed on the entire grid 1. Besides, the number, size, shape and location of the meshes are not limited.

The grid 1 includes a plurality of first engagement portions 11, and the body 2 includes a plurality of second engagement portions 21. Each first engagement portion 11 is engaged with a respective one of the plurality of second engagement portions 21. Therefore, the number of the plurality of first engagement portions 11 is preferably equal to the number of the plurality of second engagement portions 21.

Specifically, in this embodiment, each first engagement portion 11 is in a form of a protrusion, each second engagement portion 21 is in a form of a notch, and each second engagement portion 21 has a hook portion 22. The hook portion 22 extends along the second engagement portion 21. By such an arrangement, each first engagement portion 11 can be received in a corresponding second engagement portion 21, and the hook portion 22 of the second engagement portion 21 can limit the position of the first engagement portion 11, so that the first engagement portion 11 is engaged with the second engagement portion 21. By engaging the plurality of second engagement portions 21 with the plurality of first engagement portions 11, the grid 1 can firmly couple with the body 2.

Besides, in this embodiment, the grid 1 and the body 2 are in circular shapes. The plurality of first engagement portions 11 can be formed on an outer periphery of the grid 1, and the plurality of second engagement portions 21 can be formed on an outer periphery of the body 2. In accordance with the above structure, by aligning one first engagement portion 11 with a corresponding second engagement portion 21 and rotating the grid 1 relative to the body 2, the first engagement portion 11 will abut against the hook portion 22 of the second engagement portion 21. Thus, the first engagement portion 11 can be engaged with the second engagement portion 21 after the rotation of the grid 1 relative to the body 2.

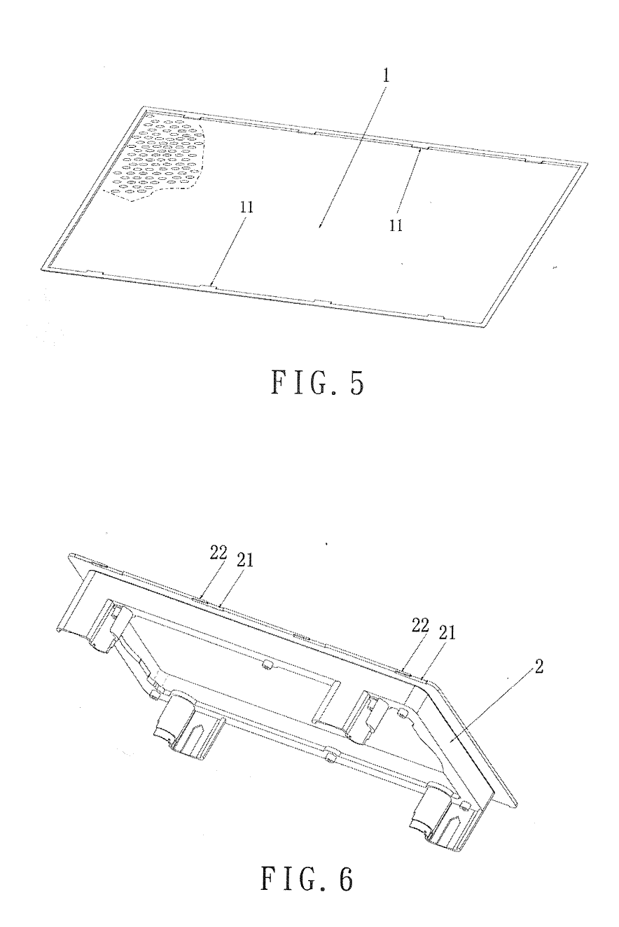

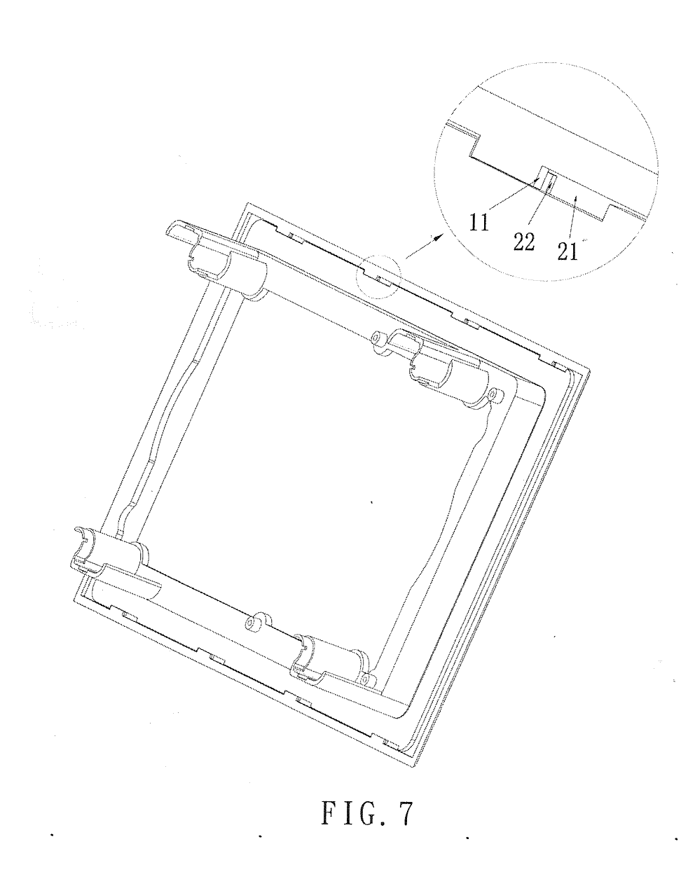

With reference to FIGS. 5-7, an in-wall/in-ceiling speaker with grid assembly according to another embodiment of the present invention is shown. Although only partial meshes are shown in FIG. 5, a person having ordinary skill in the art can understand that the meshes can be formed on the entire grid 1. In this embodiment, the grid 1 and the body 2 are in quadrilateral shapes. The plurality of first engagement portions 11 can be formed at a side of the grid 1, and the plurality of second engagement portions 21 can be formed at a side of the body 2. The side of the grid 1 can be slightly longer than the side of the body 2. In accordance with the above structure, by aligning one first engagement portion 11 with a corresponding second engagement portion 21 and pushing the grid 1 along the body 2, the first engagement portion 11 will abut against the hook portion 22 of the second engagement portion 21. Thus, the first engagement portion 11 can be engaged with the second engagement portion 21 after pushing the grid 1 along the body 2.

With the in-wall/in-ceiling speaker with grid assembly of the embodiments of the present disclosure, the grid 1 can couple with the body 2 by engaging the plurality of second engagement portions 21 with the plurality of first engagement portions 11. Accordingly, in comparison with the conventional air-convectional device which uses the magnet 3 to attach the grid 1 to the body 2, the in-wall/in-ceiling speaker with grid assembly of the present disclosure does not need any magnet, so that the production costs of the in-wall/in-ceiling speaker with grid assembly is reduced. Moreover, the engagement strength between the plurality of first engagement portions 11 and the plurality of the second engagement portions 21 will not decrease as time goes on, and thus the grid 1 is guaranteed to firmly couple with the body 2, which prevents the grid 1 from falling off from the body 2.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. An in-wall/in-ceiling speaker with grid assembly, comprising:
a grid including a plurality of first engagement portions; and
a body including a plurality of second engagement portions, with the grid coupling with the body by engaging the plurality of second engagement portions with the plurality of first engagement portions.

2. The in-wall/in-ceiling speaker with grid assembly as claimed in claim 1, wherein each first engagement portion is in a form of a protrusion, wherein each second engagement portion is in a form of a notch, wherein with each second engagement portion has a hook portion extending along the second engagement portion.

3. The in-wall/in-ceiling speaker with grid assembly as claimed in claim 2, with each first engagement portion received in a respective one of the plurality of second engagement portions, and with the hook portion of the second engagement portion limiting the position of the first engagement portion.

4. The in-wall/in-ceiling speaker with grid assembly as claimed in claim 1, wherein the grid and the body are in circular shapes.

5. The in-wall/in-ceiling speaker with grid assembly as claimed in claim 4, with the plurality of first engagement portions formed on an outer periphery of the grid, and with the plurality of second engagement portions formed on an outer periphery of the body.

6. The in-wall/in-ceiling speaker with grid assembly as claimed in claim 1, wherein the grid and the body are in quadrilateral shapes.

7. The in-wall/in-ceiling speaker with grid assembly as claimed in claim 6, with the plurality of first engagement portions formed at a side of the grid, and with the plurality of second engagement portions formed at a side of the body.

8. The in-wall/in-ceiling speaker with grid assembly as claimed in claim 1, wherein the number of the plurality of first engagement portions is equal to the number of the plurality of second engagement portions.
